(19) United States
(12) Patent Application Publication
(10) Pub. No.: US 2007/0064712 A1
(43) Pub. Date: Mar. 22, 2007

(54) Method and apparatus for transmitting additional information on digital broadcast through home network

(75) Inventors: Kwang-chul Lee, Suwon-si (KR); Ki-seok Chang, Suwon-si (KR); Akhil Chapalamadugu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/522,351

(22) Filed: Sep. 18, 2006

(30) Foreign Application Priority Data
Sep. 16, 2005 (KR) 10-2005-0086994

(51) Int. Cl. H04L 12/28

(52) U.S. Cl. 370/395.5

(57) ABSTRACT

A method and apparatus that provide additional information on a digital broadcast to home network devices in a home network, the method including receiving the additional information on a digital broadcast from an external network; determining at least one device among the home network devices as a receiving device of the additional information; and transmitting the additional information to the receiving device.

### CROSS-REFERENCE TO RELATED PATENT APPLICATION

This application claims priority from Korean Patent Application No. 10-2005-0086994, filed on Sep. 16, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to a method of transmitting additional information on a digital broadcast, and more particularly, to a method and apparatus in which a home gateway selectively transmits additional information on a digital broadcast received from an external network to home network devices at the request of the devices.

2. Description of the Related Art

Digital TVs (DTVs) and set top boxes (STBs) are becoming widely used both domestically and abroad. These devices can receive digital broadcasts. As broadcasting and communication devices are integrated with each other, Internet Protocol TVs (IPTVs) have emerged, and standardization and research on a home network-based broadcast service with a new configuration are actively making progress. Multimedia home platform home network (MHP-HN) groups and digital living network alliance (DLNA) groups are representative standard groups on a digital broadcast reception. The STB, the DTV, and a personal video recorder (PVR) are core elements of a home network-based digital broadcast system. A broadcast service transmitted from an external broadcast network is transmitted to a home network via the STB. The broadcast service is received and displayed by the DTV. A broadcast signal can be recorded and shared through the home network by using the network-based PVR.

FIG. 1 illustrates a conventional digital broadcast system.

In the conventional digital broadcast system illustrated in FIG. 1, a PVR 102 is embedded in a STB 101, and the STB 101 records a digital broadcast signal transmitted through a satellite, a cable, or a ground wave by using the PVR 102. A DTV 103 is directly connected to the STB 101, and receives and displays a digital broadcast received through the satellite, the cable or the ground wave, or displays broadcast content stored in the PVR 102.

The STB 101 and the DTV 103 directly receive additional information on a digital broadcast service through a broadcast network using the satellite, the cable or the ground wave. The additional information may be used for an electronic program guide (EPG), so that a user can obtain information on a broadcast program. The additional information uses digital video broadcasting service information (DVB-SI) 104 in a multimedia home platform (MHP), and uses program and system information protocol (PSIP) in an open cable application platform (OCAP).

FIG. 2 illustrates a home network-based digital broadcast system.

Referring to FIG. 2, in the home network 205, the DTV 203, the STB, and the PVR 202 are separate devices. Electronic home appliances or communication products such as the STB, the PVR 202, and the DTV 203 are IP based devices, which communicate with one another to share data.

A home gateway 206 is connected not only to a broadcast access network 204 using a satellite, a cable or a ground wave but also to a broadband access network 207 using the Internet. In addition, the home gateway 206 receives a broadcast service such as a live broadcast or Video on Demand (VoD), and also receives relative additional information to be transmitted to home network devices such as the PVR 202 and the DTV 203. The additional information may be transmitted by using DVB-SI, PSIP, and service discovery and selection (SD&S).

The home gateway receives service information such as DVB-SI through the broadcast network 204, and receives additional information such as SD&S through the broadband network 207 so as to transmit the information to the home network 205. In this case, since a lot of users use an external access network whereas only a few users use the home network 205, if the home gateway transmits the additional information received from the external access network to the home network 205, traffic may increase, thereby wasting bandwidth. However, there are no obvious measures or standards to prevent this problem. Therefore, a method of effectively transmitting the additional information of the digital broadcast through the home network 205 is needed.

### SUMMARY OF THE INVENTION

The present invention provides a method and apparatus for transmitting additional information on a digital broadcast, which reduces home network traffic by transmitting the additional information at the request of home network devices.

According to an aspect of the present invention, there is provided a method of providing additional information on a digital broadcast to home network devices in a home network, the method comprising: (a) receiving the additional information on a digital broadcast from an external network; (b) determining at least one device among the home network devices as the receiving device of the additional information; and (c) transmitting the additional information to the receiving device.

In the aforementioned aspect of the method, in operation (b), the receiving device may be determined to be the device which requests the additional information after the additional information is received, or the receiving device may be determined to be the device which requests the additional information prior to the receiving of the additional information, and requests the additional information to be transmitted if the additional information is received within a predetermined time period after the request for the additional information is made, and the time that the additional information is received may be within the time period. In addition, the receiving device may not be determined to be device which has already received the additional information.

An aspect of the present invention provides a computer-readable medium having embodied thereon a computer program for executing the method of providing additional information on a digital broadcast.

According to another aspect of the present invention, there is provided an apparatus for providing additional information on a digital broadcast to home network devices in a home network, the apparatus comprising: a determining unit that determines at least one device among the home network devices as receiving device of the additional information; and a transmitting/receiving unit that receives the additional information from an external network and transmits the additional information to the receiving device.

According to another aspect of the present invention, there is provided a method of obtaining additional information on a digital broadcast in home network devices, the method comprising: (a) requesting the additional information on a digital broadcast to a home gateway, where the home gateway communicates with an external network and a home network; and (b) receiving the additional information transmitted in response to the requesting, wherein the additional information is selectively transmitted only to a device that requests the additional information among the home network devices.

An aspect of the present invention also provides a computer-readable readable medium having embodied thereon a computer program for executing the method of receiving additional information Qn a digital broadcast in home network devices.

According to another aspect of the present invention, there is provided a home network device receiving additional information on a digital broadcast from an external network via a home gateway connected to the home network, the device comprising: a requesting unit requesting the additional information on a digital broadcast to the home gateway; and a receiving unit receiving the additional information transmitted in response to the requesting, wherein the additional information is selectively transmitted only to a device that requests the additional information among the home network devices.

The aforementioned additional information may be at least one among information on a type of a network through which broadcast content of the digital broadcast is transmitted, information on a channel of the digital broadcast, and information on a broadcast program of the digital broadcast.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional digital broadcast system;

FIG. 2 illustrates a conventional home network-based digital broadcast system;

FIG. 3 is a flowchart illustrating a method of transmitting additional information on a digital broadcast to.a home network according to an exemplary embodiment of the present invention;

FIG. 4 is a detailed flowchart illustrating a method of transmitting the additional information on the digital broadcast to the home network according to an exemplary embodiment of the present invention;

FIG. 5 illustrates how messages flow when a scheduled transmission is requested and cancelled;

FIG. 6 illustrates how messages flow when the additional information is immediately transmitted, according to an exemplary embodiment of the present invention;

FIG. 7 illustrates a table of parameters used in messages according to an exemplary embodiment of the present invention; and

FIG. 8 is a block diagram of a home gateway and a home network device in a home network according to an exemplary embodiment of the present invention.

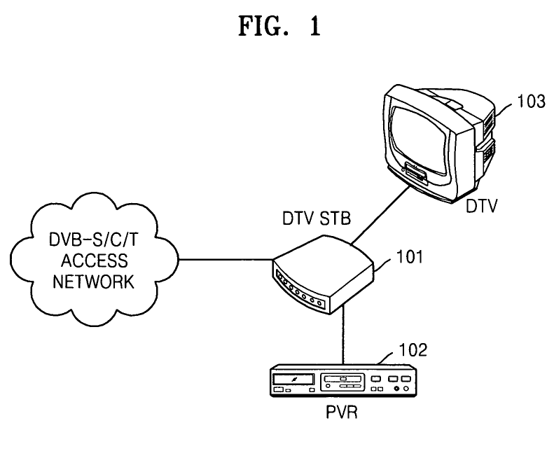

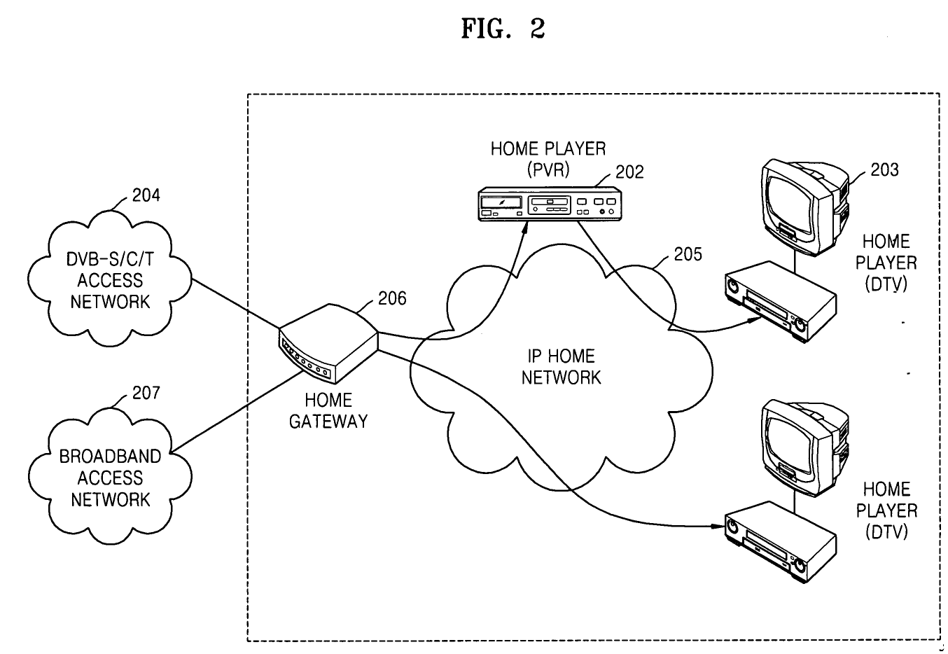

### DETAILED DESCRIPTION OF EXEMPLARY EMBODIMENTS

Hereinafter, the present invention will be described in detail by explaining exemplary embodiments of the invention with reference to the attached drawings.

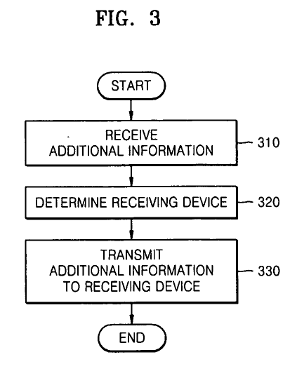

FIG. 3 is a flowchart illustrating a method of transmitting additional information on a digital broadcast to a home network according to an exemplary embodiment of the present invention.

A home gateway receives the additional information on a digital broadcast from an external network (operation 310). The additional information on a digital broadcast may be information on a type of a network through which broadcast content of the digital broadcast is transmitted, information on a channel of the digital broadcast, or information on a broadcast program of the digital broadcast. Next, a receiving device receiving the additional information is determined (operation 320), and the additional information is transmitted to the receiving device (operation 330). Instead of broadcasting all of the additional information to the home network, the home gateway selectively transmits the received additional information to home network devices, thereby significantly reducing traffic of the home network. The receiving device is determined according to the request of the home network devices. This will be described in detail later.

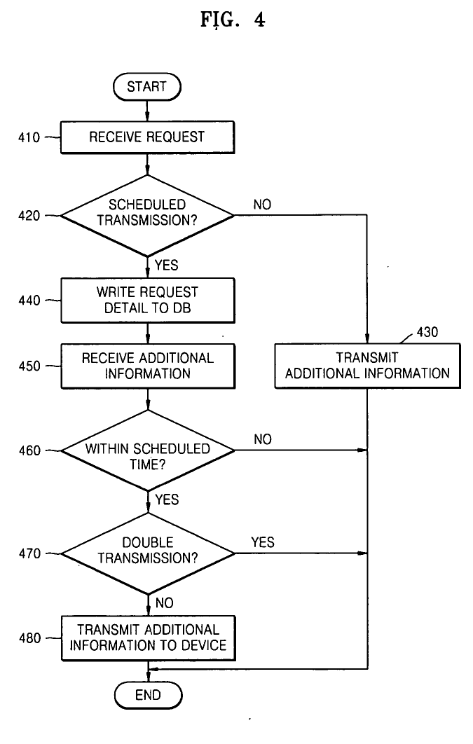

FIG. 4 is a detailed flowchart illustrating a method of transmitting the additional information on the digital broadcast to the home network according to an exemplary embodiment of the present invention.

The home gateway receives a request for the additional information from the home network devices (operation 410). The requested additional information may vary depending on the devices. The home gateway determines whether the request is a scheduled transmission (operation 420). According to the current exemplary embodiment of the present invention, the request is an immediate transmission or a scheduled transmission. If an immediate transmission is requested, the additional information is transmitted immediately. If a scheduled transmission is requested, the additional information is transmitted when the request is received within a scheduled time period. When the transmitted additional information is modified and then the modified additional information is received again, the home gateway retransmits the received additional information to a relevant device. However, when the same additional information is received for the second time, the information is preferably not retransmitted to the device which has already received the information.

If it is determined that the request is not a scheduled transmission, the requested additional information is immediately transmitted to a relevant device (operation 430). If it is determined that the request is a scheduled transmission, a detail of the request is written in a database (operation 440). When the home gateway receives the additional information, the database is read to select a request for the received additional information, where a scheduled time of the request has not come yet (operation 460). To prevent a double transmission, receiving devices are determined by excluding devices which have already received the same information of the received additional information among devices to which the selected request is transmitted. The additional information is transmitted to the receiving devices (operation 480).

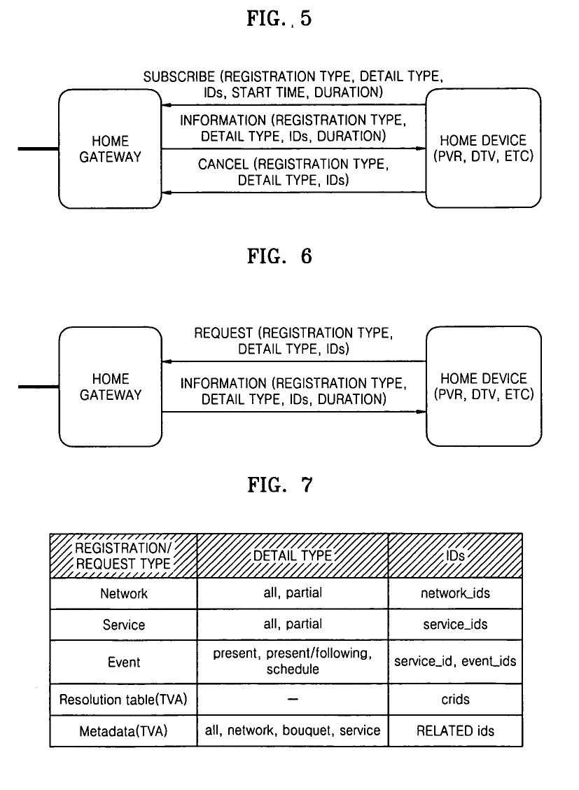

FIG. 5 illustrates how messages flow when a scheduled transmission is requested and cancelled.

The home gateway stores additional information on a digital broadcast in a database DB. The additional information is received through a broadcast network or a broadband network. Home network devices such as a personal video recorder (PVR) or a digital TV (DTV) may request a scheduled transmission of the additional information to the home gateway. For the scheduled transmission, the home network devices may send a message to the home gateway in the format of Subscribe (registration type, detail type, IDs, start time, duration). The registration type and the detail type specify additional information to be transmitted to the home network devices. The IDs are identifiers of the additional information to be specified. The start time is a time for starting a scheduled transmission of the additional information. The duration is a scheduled time period. When scheduled additional information is received within the duration starting from the start time, the home gateway that receives the message Subscribe ( ) transmits the additional information to a relevant home network device. In the case of double transmission, the home gateway does not transmit the additional information. In other words, only when the additional information is modified, is the additional information transmitted to the device which requests the scheduled transmission.

FIG. 6 illustrates how messages flow when the additional information is immediately transmitted, according to an exemplary embodiment of the present invention.

The home network device sends a message to the home gateway in the format of Request (request type, detail type, IDs) to receive the additional information immediately. When the message Request ( ) is received, the home gateway immediately transmits the additional information. Since this is not a scheduled transmission of the additional information, the start time and the duration of FIG. 5 are not required.

The registration type, the detail type, and the IDs may vary depending on the usage of the home network devices, and may have values as illustrated in FIG. 7. FIG. 7 illustrates a table of parameters used in messages according to an exemplary embodiment of the present invention.

A registration/request type, a detail type, and IDs of FIG. 7 will now be described in detail.

The parameters of FIG. 7 may be used to specify information on the digital broadcast, so that a user can obtain information on a program using an electronic program guide (EPG). When the user wants to view a detail of the EPG, a home network device may send information on Network and Service to parameters of Request ( ). Then, information on relative network and service is received to be used in the EPG. For example, in the case of the information on Network, when Request (network, all) is sent to the home gateway, the home gateway responds thereto by sending information on all networks to which the home gateway is connected. If the user wants to obtain information on only a partial network, the network has to be specified using network_ids. Also, in the case of information on the Service, the information may be requested in the same manner. Information on Event may use a message in the format of Request (event, schedule, start_time, duration). In this case, the home gateway transmits information on all program schedules during the duration starting from the start_{—time} . In the case of Metadata such as a TV-Anytime, when Request (Metadata(TVA), network, network_id) is sent, the home gateway sends TVA metadata related to a service provided through a network corresponding to a network_id. Thereafter, home network devices send Subscribe( ), so that, if additional information is modified during the scheduled time span, the home network devices can receive the modified information.

The parameters of FIG. 7 may be used when a network-based PVR carries out scheduled recording. According to the aforementioned EPG, the user uses the parameters to record a program scheduled to be broadcasted. If the user knows an event_id of the program to be recorded, Subscribe (event, present, event_id, start time, duration) is sent to the home gateway. If information on a present event having its event-id is received from an external network for the first time, or a detail of the invent information is modified during the duration starting from the start time, the home gateway transmits the modified information to a home network device that requests a scheduled transmission of the modified information. As a result, the home network device receives information on the event corresponding to the event_id and records the program at a correct time. The user may know the event_id of the selected program by sending a message Request (event, schedule, start_time, duration) to the home gateway in advance. If several programs are scheduled to be recorded, information on the present event is requested, and several event_ids, and not just one event_id, may be included in the message. If the information on the program uses TV-Anytime (TVA) metadata, desired information may be specified only when crids of the selected program can be known. In this case, the message may have the format of Subscribe (Resolution table(TVA), -, crids, start time, duration). The home gateway transmits the information to the home network device that requests the scheduled transmission only when a Resolution table including the crids is received for the first time, or a detail of the information is modified during the duration starting from the start time. The home network device may carry out recording at a correct time by using the Resolution table. Alternatively, Subscribe (event, present, event_ids, start time, duration) is sent by using the event_ids included in the Resolution table to obtain information on the present event as described above. Recording may be carried out at a correct time by using the information on the present event.

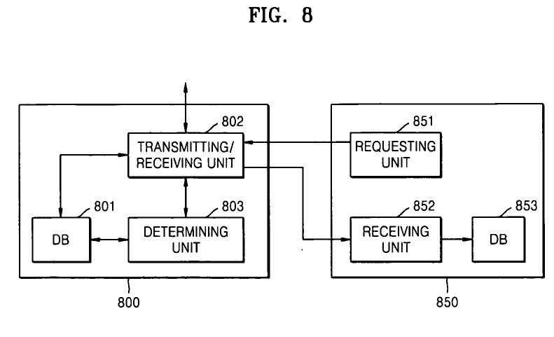

FIG. 8 is a block diagram of a home gateway 800 and a home network device 850 in a home network according to an exemplary embodiment of the present invention.

Referring to FIG. 8, the home gateway 800 includes a transmitting/receiving unit 802, a determining unit 803, and a database 801. The home network device 850 includes a requesting unit 851, a receiving unit 852, and a database 853.

The transmitting/receiving unit 802 of the home gateway 800 communicates with the home network and an external network, receives additional information on a digital broadcast through the external network, and transmits the additional information to the home network device 850 through the home network. Also, a request message for requesting the additional information may be received from the home network device 850.

The database 801 of the home gateway 800 stores various pieces of additional information received through the transmitting/receiving unit 802, and also stores the request message transmitted from the home network device 850. For convenience, one database 801 is illustrated in FIG. 8, but the additional information and the request message may be stored in different databases.

According to the request message received from the home network device 850, the determining unit 803 determines a receiving device to receive the additional information received through the transmitting/receiving unit 802 or the additional information stored in the database 801. If the request message requests an immediate transmission, relevant information is extracted from the database 801 to be transmitted immediately. If the request message requests a scheduled transmission, relevant information from the additional information received through the transmitting/receiving unit 802 during the scheduled time span is transmitted to the home network device 850. In this case, as described above, if the additional information received within the scheduled time period is the same as the additional information which is transmitted to the home network device 850 and then is retransmitted thereto without any modification, the home network device 850 is not determined as the receiving device. Preferably, the database 801 stores information on the home network device 850 and additional information transmitted to the home network device 850.

The requesting unit 851 transmits a request message for an immediate transmission of specific additional information or a request message for a scheduled transmission to the home gateway 800. In response to the request message, the receiving unit 852 receives the additional information transmitted by the home gateway 800. The database 853 stores the received additional information.

Accordingly, a home gateway in a home network transmits additional information only to a home network device that requests the additional information, and does not retransmit the same additional information to the home network device that has already received the information. Therefore, unnecessary traffic of the home network can be reduced, thereby reducing bandwidth use.

Additionally, the exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

Although the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of providing additional information on a digital broadcast to home network devices in a home network, the method comprising:
receiving the additional information on a digital broadcast from an external network;
determining at least one device among the home network devices as a receiving device of the additional information; and
transmitting the additional information to the receiving device.

2. The method of claim l, wherein the receiving additional information occurs at a scheduled time for receipt.

3. The method of claim 1, wherein the receiving additional information is received based on a request by at least one device among the home network devices.

4. The method of claim 1, wherein, in the determining operation, the receiving device is determined to be the device which requests the additional information after the additional information is received.

5. The method of claim 1, wherein, in the determining operation, the receiving device is determined to be the device which requests the additional information prior to the receiving of the additional information, and requests the additional information to be transmitted if the additional information is received within a certain time period after the request for the additional information is made, and
the time that the additional information is received is within the time period after the request for the additional information is made.

6. The method of claim 5, wherein a device which has already received the additional information is determined to not be the receiving device.

7. The method of claim 1, wherein the additional information is at least one among information on a type of a network through which broadcast content of the digital broadcast is transmitted, information on a channel of the digital broadcast, and information on a broadcast program of the digital broadcast.

8. A computer-readable medium having embodied thereon a computer program for executing the method of claim 1.

9. An apparatus for providing additional information on a digital broadcast to home network devices in a home network, the apparatus comprising:
a determining unit which determines at least one device among a plurality of home network devices as a receiving device of the additional information; and
a transmitting/receiving unit which receives the additional information from an external network and transmits the additional information to the determined receiving device.

10. The apparatus of claim 9, wherein the determining unit determines a device which requests the additional information after the additional information is received as the receiving device.

11. The apparatus of claim 9, wherein the determining unit determines the receiving device to be a device which requests the additional information prior to the receiving of the additional information and requests the additional information to be transmitted if the additional information is received within a certain time period after the request for the additional information is made, and
the time that the additional information is received is within the time period after the request for the additional information is made.

12. The apparatus of claim 1 1, wherein a device which has already received the additional information is determined to not be the receiving device..

13. The apparatus of claim 9, wherein the additional information is at least one among information on a type qf a network through which broadcast content of the digital broadcast is transmitted, information on a channel of the digital broadcast, and information on a broadcast program of the digital broadcast.

14. A method of obtaining additional information on a digital broadcast in home network devices, the method comprising:
requesting the additional information on a digital broadcast to a home gateway, where the home gateway communicates with an external network and a home network; and
receiving the additional information transmitted in response to the requesting,
wherein the additional information is selectively transmitted only to a device that requests the additional information among a plurality of home network devices.

15. The method of claim 14, wherein in the requesting the additional information, the additional information is requested to be transmitted when the additional information is received by the home gateway within a certain time period after the requesting the additional information.

16. The method of claim 14, wherein the additional information is at least one among information on a type of a network through which broadcast content of the digital broadcast is transmitted, information on a channel of the digital broadcast, and information on a broadcast program of the digital broadcast.

17. A computer-readable medium having embodied thereon a computer program for executing the method of claim 14.

18. A home network device receiving additional information on a digital broadcast from an external network via a home gateway connected to the home network, the device comprising:
a requesting unit requesting the additional information on a digital broadcast to the home gateway; and
a receiving unit receiving the additional information transmitted in response to the requesting,
wherein the additional information is selectively transmitted only to a device that requests the additional information among the home network devices.

19. The device of claim 18, wherein the requesting unit requests the additional information to be transmitted when the additional information is received by the home gateway within a certain time period after the requesting the additional information.

20. The device of claim 18, wherein the additional information is at least one among information on a type of a network through which broadcast content of the digital broadcast is transmitted, information on a channel of the digital broadcast, and information on a broadcast program of the digital broadcast.
